(19) United States
(12) Patent Application Publication
(10) Pub. No.: US 2013/0156417 A1
(43) Pub. Date: Jun. 20, 2013

(54) OPTICAL FIBER TRANSMISSION SWITCHING DEVICE AND CONTROL METHOD THEREOF

(71) Applicants: Hui Tsuo Chou, Zhubei City (TW); John Lynn, Zhubei City (TW)

(72) Inventors: Hui Tsuo Chou, Zhubei City (TW); John Lynn, Zhubei City (TW)

(21) Appl. No.: 13/689,790

(22) Filed: Nov. 30, 2012

Related U.S. Application Data
(60) Provisional application No. 61/565,493, filed on Nov. 30, 2011.

(51) Int. Cl. G02B 6/35; H04B 10/03

(52) U.S. Cl. CPC G02B 6/35; H04B 10/03
USPC 398/5; 385/16; 385/21; 385/22

(57) ABSTRACT

An optical fiber transmission switching device includes a first transmission port; a second transmission port; a terminal-end input port; a terminal-end output port; a first and a second optical module respectively including an electrical input port, an electrical output port, and a bi-directional optical port, wherein the two bi-directional optical ports are coupled to the first and the second transmission port respectively; a first and a second laser driver circuit respectively coupled to the first and the second optical module; a first and a second electrical amplifier respectively coupled to the first and the second optical module; a first switching module coupled to the terminal-end input port and the first and the second laser driver circuit; a second switching module coupled to the first and the second electrical amplifier and the terminal-end output port.

### CROSS-REFERENCE TO RELATED APPLICATIONS

This application claims the benefit of the filing date priority of a co-pending U.S. Provisional Application No. 61/565,493 filed on Nov. 30, 2011, the disclosure of which is incorporated herein by reference in its entirety.

### BACKGROUND OF THE INVENTION

1. Field of the Invention

The present invention relates to optical communications, and more particularly, to an optical fiber transmission switching device.

2. Related Art

Among the recent optical communication products, the small form factor (SFF) optical transceiver module is further evolved to the small form factor pluggable (SFP) optical transceiver module. The product manufactured according to SFP standard has a more compact volume with the hot-pluggable function. Therefore, through the utilization of SFP transceiver, more transceiver modules can be installed in the same space. Without turning OFF the facility, the modules can be removed and replaced, such that it is helpful to setup the system, perform system debug, and reduce the maintenance cost.

Refer to FIG. 1, a schematic diagram of an optical fiber transmission switching device in the art. The optical fiber transmission switching device is applicable to an optical network, such as a passive optical network. The common approach is to install an additional redundant optical channel beside the main optical channel for transmitting the optical signals carrying data. The redundant optical channel and the main optical channel configure an automatic switching device. When the main optical channel fails, this automatic switching device switches the channel from the main optical channel to the redundant optical channel. However, this automatic switching device can not monitor the status of the redundant optical channel, such that automatic switching device can not determine whether the redundant optical channel functions normally. If the redundant optical channel also fails, not only data transmission function fails but also the network/information security risk raises. Furthermore, the redundant optical channel requires additional optical line terminal, (OLT) and optical network unit (ONU), more installation space is required and cost for establishing the network system raises.

### SUMMARY OF THE INVENTION

In view of the above problems, the present invention provides an optical fiber transmission switching device, which integrates transceiver components for a main optical channel and a redundant optical channel within a Small form-factor pluggable (SFP) transceiver module, and the interfaces of the terminal-end are shared. Therefore, the optical fiber transmission switching device of the present invention reduces the cost for establishing the network system, reduces installation space, and can monitor the status of the redundant optical channel.

In one or more embodiments of the present invention, an optical fiber transmission switching device for an optical network comprises the following features

A channel-end interface includes a first transmission port and a second transmission port;

A terminal-end interface includes a terminal-end input port and a terminal-end output port;

A first optical module includes a bi-directional optical port coupled to the first transmission port, an electrical output port, an electrical input port, a laser diode and an optical sensor. The laser diode transforms electrical signals input via the electrical input port into optical signals and outputs the optical signals via the bi-directional optical port, and the optical sensor transforms the optical signals input via the bi-directional optical port into electrical signals and outputs the electrical signals via the electrical output port.

A second optical module includes a bi-directional optical port coupled to the second transmission port, an electrical output port, an electrical input port, a laser diode and an optical sensor. The laser diode transforms the electrical signals input via the electrical input port into the optical signals and output the optical signals via the bi-directional optical port, and the optical sensor transforms the optical signals input via the bi-directional optical port into electrical signals and output the electrical signals via the electrical output port.

A first laser driver circuit includes an input port and an output port. The output port is coupled to the electrical input port of the first optical module.

A second laser driver circuit includes an input port and an output port. The output port is coupled to the electrical input port of the second optical module.

A first electrical amplifier includes an input port and an output port. The input port is coupled to the electrical output port of the first optical module.

A second electrical amplifier includes an input port and an output port. The input port is coupled to the electrical output port of the second optical module.

A first switching module includes an input port, a first output port and a second output port. The input port is coupled to the terminal-end input port, the first output port is coupled to the input port of the first laser driver circuit, and the second output port is coupled to the input port of the second laser driver circuit.

A second switching module includes a first input port, a second input port and an output port.

The first input port is coupled to the output port of the first electrical amplifier, the second input port is coupled to the output of the second electrical amplifier, and the output port is coupled to the terminal-end output port.

When the transmission of the optical signals at the first transmission port functions normally, the electrical signals at the terminal-end output port are transformed from the optical signals received via the first transmission port; when the transmission of the optical signals at the first transmission port malfunctions, the electrical signals at the terminal-end output port are transformed from the optical signals received via the second transmission port.

In one or more embodiments of the present invention, an optical fiber transmission switching device further includes a micro-controller circuit coupled to the first optical module and the second optical module, functioning for digital diagnostics monitoring (DDM).

In one or more embodiments of the present invention, a control method applicable to the optical fiber transmission switching device as described above. The control method comprises the following steps:

Firstly, resetting the optical fiber transmission switching device, and designating the first optical channel as the main channel for transmitting data carried by optical signals.

Secondly, detecting whether the designation of the main channel is changed to another optical channel; when the designation of the main channel is changed, changing the main channel to the other optical channel.

Finally, detecting whether the main channel issues a channel failure signal, when the main channel issues the channel failure signal, micro-controller circuit outputs a system channel failure and then returning the step for detecting whether the designation of the main channel is changed to another optical channel; when the main channel issues the channel failure signal, returning the step for detecting whether the designation of the main channel is changed to another optical channel without issuing the system channel failure.

In one or more embodiments of the present invention, a control method applicable to the optical fiber transmission switching device as described above. The control method comprises the following steps:

Firstly, resetting the optical fiber transmission switching device, and designating the first optical channel as a main channel for transmitting data carried by optical signals.

Secondly, detecting whether the designation of the main channel is changed to another optical channel; when the designation of the main channel is changed, changing the main channel to the other optical channel.

Finally, detecting whether setting values of the first laser driver circuit and second laser driver circuit are changed; when the setting values are changed, switching ON or switching OFF the first laser driver circuit and second laser driver circuit according to the setting values and storing the setting values, and then returning the step for detecting whether the designation of the main channel is changed to another optical channel; when the setting values remain unchanged, returning the step for detecting whether the designation of the main channel is changed to another optical channel.

Under the condition to be compatible to the currently existing connectors, the optical fiber transmission switching device of the present invention provides an additional transceiver as a redundant data transmission channel. The size of the transceiver is reduced and the number of the sockets required on the optical line terminal (OLT) or the optical network unit (ONU). Such a redundant data transmission channel can also function for digital diagnostics monitoring (DDM). Therefore, statuses of parts or channels are monitored by the optical network, so as to optimize the control strategy.

### BRIEF DESCRIPTION OF THE DRAWINGS

The present invention will become more fully understood from the detailed description given herein below for illustration only, and thus not limitative of the present invention, wherein:

FIG. 1 is a block diagram of an optical fiber transmission switching device in the art;

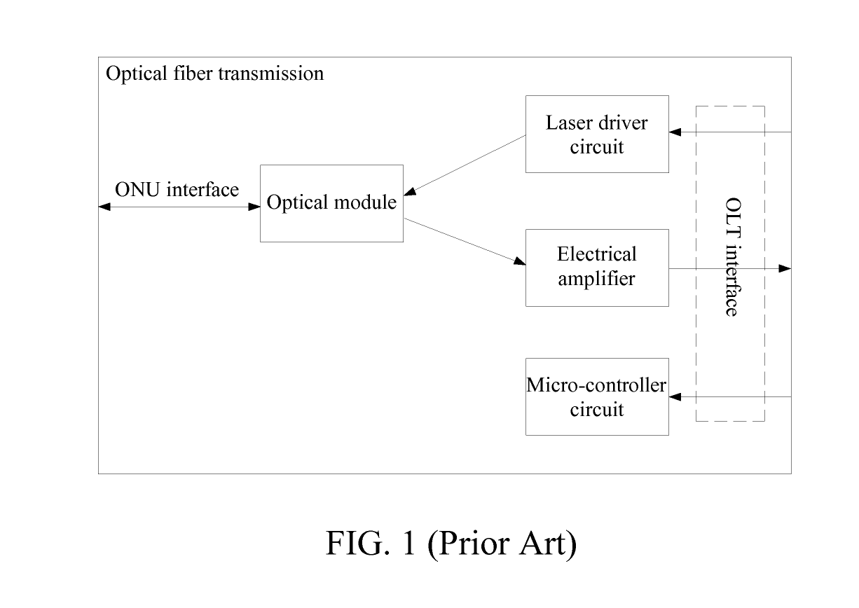

FIG. 2 is a block diagram an optical fiber transmission switching device according to an embodiment of the present invention;

FIG. 3 is a block diagram related to signal receiving function of the optical fiber transmission switching device according to the embodiment of the present invention;

FIG. 4 is a flow chart of a control method for the optical fiber transmission switching device in FIG. 3 of the present invention;

FIG. 5 is a block diagram related to signal output function of the optical fiber transmission switching device according to the embodiment of the present invention;

FIG. 6 is a flow chart of a control method for the optical fiber transmission switching device in FIG. 3 of the present invention;

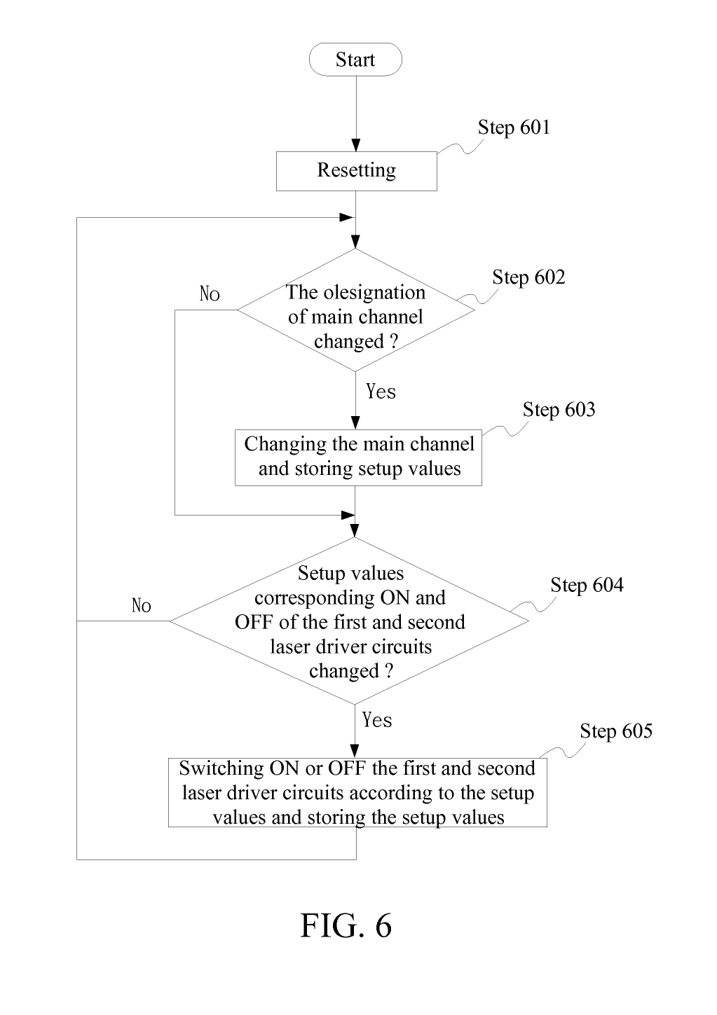

FIG. 7 is an explosive view of a small form-factor pluggable transceiver adopting the optical fiber transmission switching device according to the embodiment of the present invention;

FIG. 8 is a perspective view of the small form-factor pluggable transceiver in FIG. 7; and

FIG. 9 is a schematic diagram of an optical network adopting the optical fiber transmission switching device according to the embodiment of the present invention.

### DETAILED DESCRIPTION OF THE INVENTION

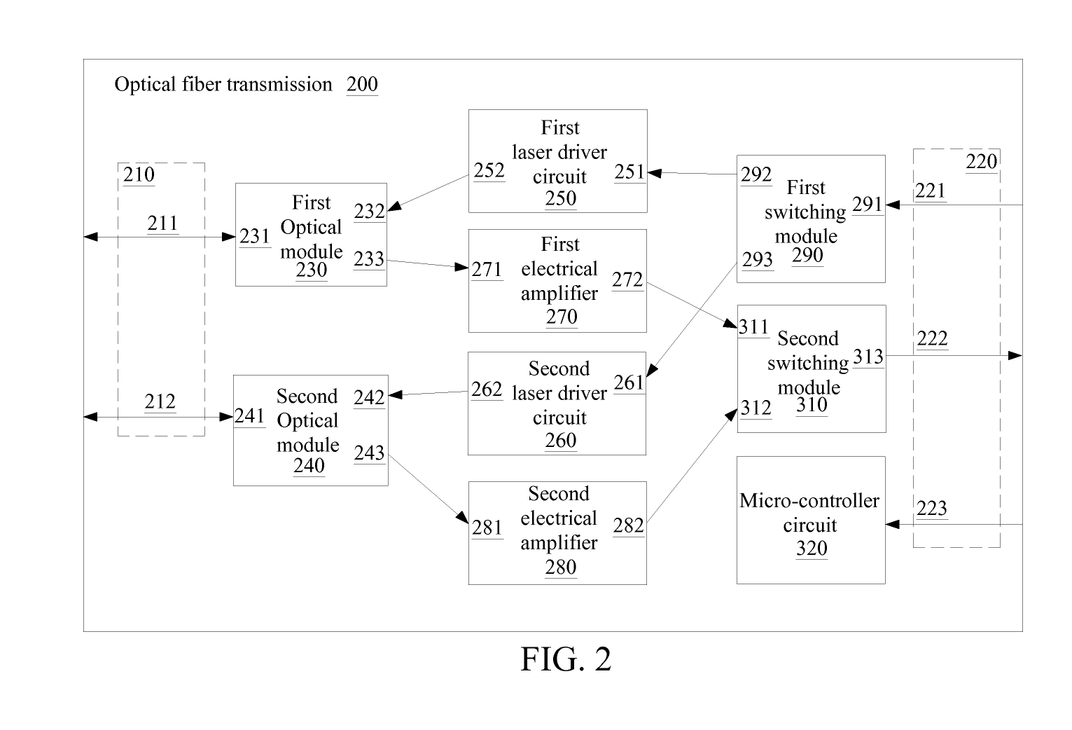

Refer to FIG. 2, a schematic diagram of the optical fiber transmission switching device 200 in the present invention. The optical fiber transmission switching device 200 is applicable to an optical network, for example a passive optical network (PON).

The channel-end interface 210 includes a first transmission port 211 and a second transmission port 212 coupling to the optical channels of the optical network to transmitting optical signals.

The terminal-end interface 220 includes a terminal-end input port 221 and a terminal-end output port 222, for transmitting electrical signals between the optical line terminal (OLT) and the optical network unit (ONU), so as to perform data transmission and system control. In one example, the terminal-end interface 220 includes twenty pins interface applicable to small form-factor pluggable (SFP) transceiver multi-source agreement (MSA).

The first optical module 230 and the second optical module 240 respectively include a bi-directional optical port 231, 241, an electrical output port 233, 243, an electrical input port 232, 242, a laser diode and an optical sensor. The two bi-directional optical ports 231, 241 are respectively coupled to the first transmission port 211 and the second transmission port 212. The laser diodes transform the electrical signals input via the electrical input ports 232, 242 into optical signals. And laser diodes output the optical signals via bi-directional optical ports 231, 24. The optical sensors respectively transform the optical signals input via the bi-directional optical ports 231, 241 into the electrical signals, and output the electrical signals via electrical output port 233, 243.

The first laser driver circuit 250 and the second laser driver circuit 260 respectively include an input port 251, 261 and an output port 252, 262. The output ports 252, 262 are respectively coupled to the electrical input ports 232, 242 of the first optical module and the second optical module. The first laser driver circuit 250 and the second laser driver circuit 260 generate electrical driving power to drive the laser diodes of the first optical module 230 and the second optical module 240.

The first electrical amplifier 270 and the second electrical amplifier 280 respectively include an input port 271, 281 and an output port 272, 282. The two input ports 271, 281 are respectively coupled to the electrical output ports 233, 243 of the first optical module 230 and the second optical module 240. The first electrical amplifier and the second electrical amplifier 280 respectively receive electrical signals generated by the optical sensors of the first optical module 230 and the second optical module 240 and amplify the received electrical signals. Under specific condition, the electrical signals generated by the optical sensor may be very weak. The first electrical amplifier 270 and the second electrical amplifier 280 amplify received electrical signals according to designated signal gains. The first electrical amplifier 270 and the second electrical amplifier 280 also improve signal-to-noise ratio (SNR) of amplified electrical signals, so as to reduce data error rate and precisely determine energy level of the signals when processing the signals. The signal gains can be real timely varied according to the operation condition or fixed values.

The first switching module 290includes an input port 291, a first output port 292 and a second output port 293. The input port 291 is coupled to the terminal-end input port 221. The first output port 292 and the second output port 293 are respectively coupled to the input ports 251, 261 of the first laser driver circuit 250 and the second laser driver circuit 260. The first switching module 290 is used to transmit the electrical signals from the terminal-end input port 221 to the first output port 292 and the second output port 293 simultaneously, or to transmit the electrical signals to one of the first output port 292 and the second output port 293 in accordance with the received control signal.

The second switching module 310 includes a first input port 311, a second input port 312 and output port 313. The first input port 311 is coupled to the output port 272 of the first electrical amplifier 270, the second input port 312 is coupled to the output port 282 of the second electrical amplifier 280, and the output port 313 is coupled to the terminal-end output port 222. in accordance with the control signal, the second switching module 310 switches the terminal-end output port 222 to be coupled to one of the output port 272 of the first electrical amplifier 270 and the output port 282 of the second electrical amplifier 280.

Furthermore, the optical fiber transmission switching device 200 includes two bi-directional transmission ports within the channel-end interface 210. The two bi-directional transmission ports are the first transmission port 211 and the second transmission port 212. An in the terminal-end interface 220, only one bi-directional electrical transmission port is configured by the terminal-end input port 221 and the terminal-end output port 222. When to fiber sets inserts into the channel-end interface 210 of the optical fiber transmission switching device 200, one fiber set is set to be the main optical channel while the other fiber set is set to be the redundant optical channel. For example, when the system is initialized, the fiber inserting into the first transmission port 211 is defined as the first optical channel and set to be the main optical channel, and the fiber inserting into the second transmission port 212 is defined as the second optical channel and set to be the redundant optical channel. When the data transmission in the optical network functions normally, the system performs monitoring and controlling. If the transmission of the optical signals at the first transmission port 211 functions normally, the electrical signals at the terminal-end output port 222 will be signals transformed from the optical signals received from the first transmission port 211, and the optical signals output by the first transmission port 211 will be signals transformed from the electrical signals at the terminal-end input port 221. If the transmission of the optical signals at the first transmission port 211 malfunctions, the electrical signals at the terminal-end output port 222 will be signals transformed from the optical signals at the second transmission port, and the optical signals output by the second transmission port 212 will be signals transformed from the electrical signals at the terminal-end input port 221. That is, when an optical network adopting the present invention performs data transmission, if main optical channel is damaged by external or internal problems, the system will quickly set the current redundant optical channel to be the new main optical channel and perform data transmission, so as to prevent the interrupt of data transmission.

Moreover, the optical fiber transmission switching device 200 further includes a micro-controller circuit 320 coupled to the OLT or ONU via the control Bus 223, [symbol] via the control Bus 223 of the terminal-end interface 220. The control Bus 223 can be a serial Bus integrated within the internal circuit for controlling plural device, so as to simplify the hardware. The micro-controller circuit 320 controls the device according setup values in the firmware. For example, the micro-controller circuit 320 switches ON and switches OFF components in the device, so as to transmit data via the first optical channel the second optical channel according to the corresponding setup value0 The micro-controller circuit 320 also setups and monitors system parameters. For example, the micro-controller circuit 320 functions for Digital Diagnostics Monitoring (DDM), so as to real timely detecting system parameters such as temperature, input voltage, optical output power, optical input power, etc.

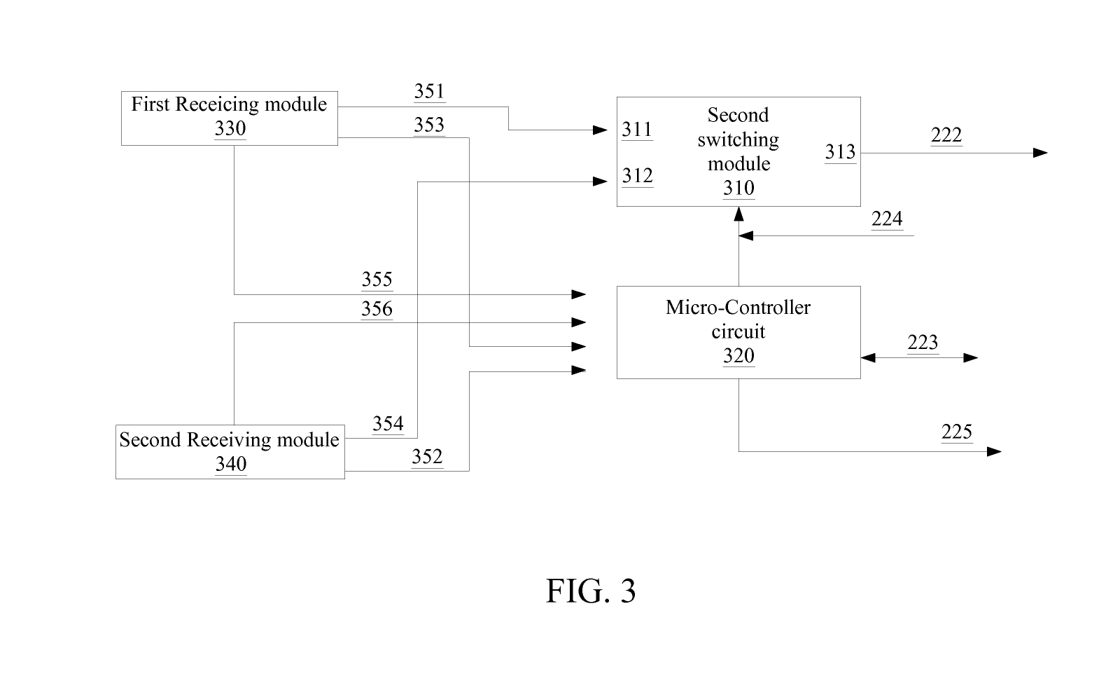

Referring to FIG. 3, the first electrical amplifier and the second electrical amplifier 280 transform optical signals received via the first optical channel and the second optical channel into a first electrical signal 351 and a second electrical signal 352. Through output ports 272, 282 of the first electrical amplifier and the second electrical amplifier 280, the first electrical signal 351 and the second electrical signal 352 are respectively transmitted to the second switching module 310 via the first input port 311 and the second input port 312 thereof. The first receiving module 330 and the second receiving module 340 respectively generate a first Digital Diagnostics Monitoring (DDM) signal 355 and a second Digital Diagnostics Monitoring (DDM) signal 356, and the first DDM signal 355 and the second DDM signal 356 are output to the micro-controller circuit 320 for determination of system status monitoring and system control. Furthermore, the first receiving module 330 and the second receiving module 340 respectively output a first channel failure signal 353 and a second channel failure signal 354 to the micro-controller circuit 320, so as to inform the system that the first optical channel or the second optical channel is crashed due to external reasons or due to malfunction of internal components. For example, when the current output by the optical sensor of the first optical module 230 is lower than a lower limit, the first receiving module 330 issues a first channel failure signal 353 to inform the first optical channel about such an abnormal event, such that the system sets the second optical channel as the new main optical channel for transmitting the optical signals.

The second switching module 310 can be a double-pole single-throw switch, controlled by the second switch control pin 224 of the terminal-end interface 220 or controlled by the micro-controller circuit, so as to selectively switch the terminal-end output port 222 to receive the first electrical signal 351 or the second electrical signal 352. For example, when the first optical channel is set to be the main optical channel for transmitting the optical signals, the second switching module 310 is controlled to switch the terminal-end output port 222 to receive the first electrical signal 351. When the second optical channel is set to be the main optical channel for transmitting the optical signals, the second switching module 310 is controlled to switch the terminal-end output port 222 to receive the second electrical signal 352. Through the second switch control pin 224, the second switching module 310 directly switches corresponding components by hardware mechanism which operates quickly. Through the control signal issued by the micro-controller circuit 320, values of registers within the micro-controller circuit 320 have to be changed through the control Bus 223 of the terminal-end interface 220, so as to output control signals to the second switching module 310. Such an operation could be slower but fewer hardware pins are required. The preferable control mechanism among the second switch control pin 224 and the micro-controller circuit 320 depends on the actual requirement of the system.

The micro-controller circuit 320 further includes one or more output port of a system channel failure signal 225, a first channel failure flag, and a second channel failure. The system channel failure signal 225 indicates whether the main optical channel functions normally. For example, when the first optical channel is set to be the main optical channel and the first optical channel malfunctions, the system channel failure signal 225 indicates corresponding status. The system channel failure signal 225 is transmitted to a pin of the terminal-end interface 220, so as to inform the OLT or the ONU about channel failure of the main optical channel real timely. The first channel failure flag and the second channel failure flag are used to store the first optical channel failure and the second optical channel failure. The first and second channel failure flag can be registers of the micro-controller circuit 320. When the micro-controller circuit 320 receives the first and the second channel failure signal 353, 354, the value corresponding to channel failure is store to the register corresponding to the first channel failure flag or the second channel failure flag. Through accesses values in the registers via the control Bus 223, the OLT or the ONU obtains the status of the first optical channel and the second optical channel. The relation among the first channel failure signal 353, the second channel failure signal 354, the setup of the main optical channel, the system channel failure signal 225, the first channel failure flag, and the second channel failure flag are illustrated in the table below, wherein 0 indicates that the channel functions normally and 1 indicates that the channel malfunctions.

| | | | system | | |
|---|---|---|---|---|---|
| 1st channel | 2nd channel | setup of the | channel | | |
| failure signal | failure signal | main optical | failure signal | 1st channel | 2nd channel |
| 353 | 354 | channel | 225 | failure flag | failure flag |
| 0 | 0 | 1st optical | 0 | 0 | 0 |
| | | channel | | | |
| | | 2nd optical | 0 | | |
| | | channel | | | |
| 0 | 1 | 1st optical | 0 | 0 | 1 |
| | | channel | | | |
| | | 2nd optical | 1 | | |
| | | channel | | | |
| 1 | 0 | 1st optical | 1 | 1 | 0 |
| | | channel | | | |
| | | 2nd optical | 0 | | |
| | | channel | | | |
| 1 | 1 | 1st optical | 1 | 1 | 1 |
| | | channel | | | |
| | | 2nd optical | 1 | | |
| | | channel | | | |

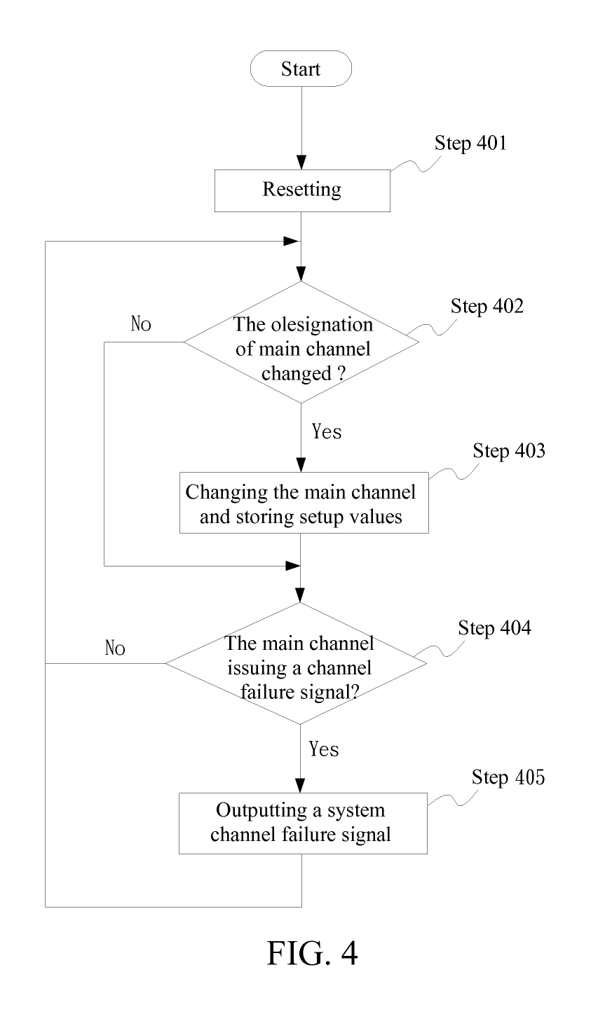

FIG. 4 is a control method of an optical fiber transmission switching device according to the present invention, applied for receiving function as shown in FIG. 3. The control method includes the following steps.

As shown in Step 401, initially, the optical fiber transmission switching device is switched ON for resetting and initializing the optical fiber transmission switching device. The optical fiber transmission switching device loads values of various system parameters; for example, the optical fiber transmission switching device restores the system parameters before the last system power OFF. Then, the first optical channel is designated as the main optical channel for transmitting data carried by optical signals.

As shown in Step 402, then the system detects detecting whether the designation of the main channel is changed to another optical channel. When the designation of the main channel is changed, the system changes the main optical channel to another optical channel as shown in

Step 403, and then executes Step 404. If the designation for the main optical channel is unchanged, the system directly executes Step 404. For example, the original designation for the main optical channel is the first optical channel, and the micro-controller circuit detects a first channel failure signal issued to indicate channel failure, the micro-controller circuit switches the second optical channel to be the new main optical channel.

As shown in Step 404, the system detects whether the main optical channel issues a channel failure signal. When the main optical channel issues the channel failure signal, the system executes Step 405 to output a system channel failure signal and then returns to Step 402. If the main optical channel does not issue the channel failure signal, the system directly returns Step 402.

For example, the original main optical channel is the first optical channel. If the first optical channel malfunctions, the micro-controller circuit will receives the first channel failure signal in Step 404 and then issues the system channel failure signal in Step 405. According to the executed program codes, the micro-controller circuit changes designation for the main optical channel to another optical channel. That is the micro-controller circuit designates the second optical channel to be the new main optical channel. Since the designation for the main optical channel is changed in Step 402, the system executes Step 403 to change the main optical channel to the other optical channel. That is the micro-controller circuit switches ON the second switching module to receive the second electrical signal via terminal-end output port. According to this embodiment, the control method as shown in FIG. 4 is applied to the optical fiber transmission switching device as shown in FIG. 3. When the main optical channel crashed due to external or other reasons, the system change the data transmission channel to the current redundant optical channel, and designates this redundant optical channel as new main optical channel, so as to prevent data transmission from being failure.

Moreover, when the designation for the main optical channel has been changed to the second optical channel, there are three approaches to handle the first optical channel issuing the first channel failure signal. First, the system continuously detects the first channel failure signal. Once the first channel failure signal is interrupted, the first optical channel is repaired and can function normally. At this time, the micro-controller circuit automatically changes the designation for the main optical channel to the first optical channel. Second, the micro-controller circuit does not change the designation for the main optical channel unless the user manually changes the designation for the main optical channel. That is to say, when the first optical channel is repaired and can function normally, and the user may manually changes the designation for the main optical channel to the first optical channel. Third, the system continuously uses the second optical channel as the main optical channel, once the second channel failure signal is detected, the micro-controller circuit automatically the designation for the main optical channel as the first optical channel.

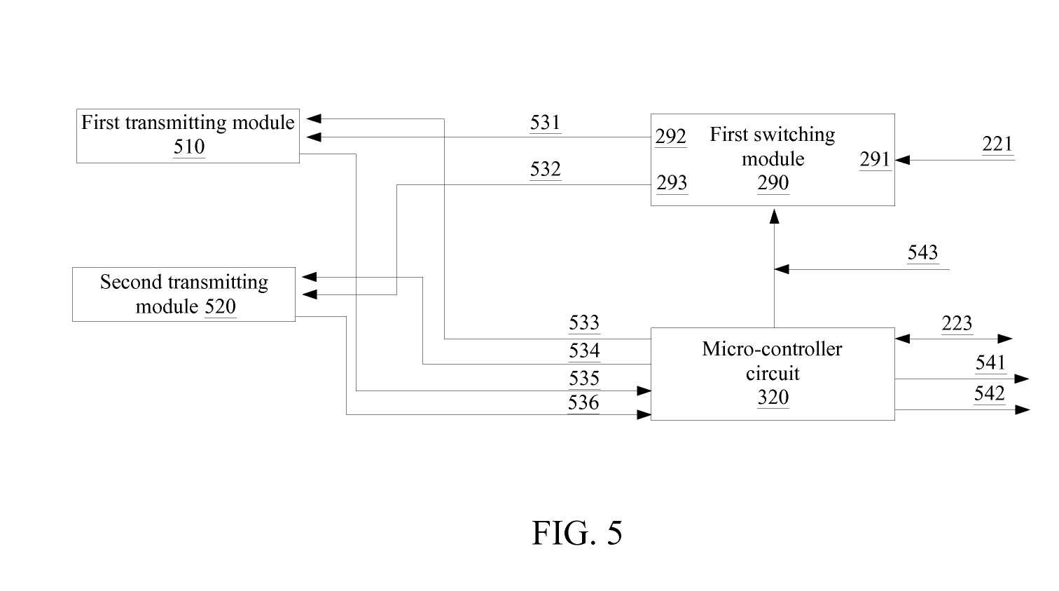

FIG. 5 is a control method of an optical fiber transmission switching device according to the present invention, applied for transmitting function. The first optical module 230 and the second optical module 240 of the optical fiber transmission switching device 200 as shown in FIG. 2 are respectively included within the first transmitting module 510 and the second transmitting module 520. The combination of the first laser driver circuit 250 and the second laser driver circuit 260 is used to receive the first electrical signal 531 and the second electrical signal 532 from the first switching module 290 via the first output port 292 and the second output port 293 thereof. And then the combination of the first laser driver circuit 250 and the second laser driver circuit 260 transform the electrical signals into optical signals and output the optical signals to the first optical channel and the second optical channel. Meanwhile the first transmitting module 510 and the second transmitting module 520 respectively output the first transmitting module failure signal 535 and the second transmitting module failure signal 536 to the micro-controller circuit 320, so as to inform that transmission of signal is abnormal due to malfunction of the first transmitting module 510 and the second transmitting module 520. For example, when system detects that the energy level of the optical signals transmitted by the first transmitting module 510 remains lower than required level, the first transmitting module 510 issues the first transmitting module failure signal 535 to inform the system about the abnormal situation of the first optical channel, such that the system can perform necessary response. For example, the system changes the designation of the main optical channel for the optical signals to the second optical channel.

The first switching module 290 can be a single-pole double-throw switch controlled by the first switch control pin 543 of the terminal-end interface 220 or controlled by the micro-controller circuit 320, so as to selectively switch the terminal-end input port 221 to couple to the input port 251 of the first laser driver circuit 250 or the input port 261 of the second laser driver circuit 260. For example, when the main optical channel carrying the optical signals is the first optical channel, the first switching module 290 switches the terminal-end input port 221 to couple to the input port 251 of the first laser driver circuit 250; on the contrary, when the main optical carrying the optical signals is the second optical channel, the first switching module 290 switches the terminal-end input port 221 to couple to the input port 261 of the second laser driver circuit 260. The advantage of using the first switch control pin 543 to control the first switching module 290 is that such an operation via hardware mechanism control is quick. On the contrary, before issuing the control signal, the registers setup values within the micro-controller circuit 320 has to be changed via the control Bus 223 of the terminal-end interface 220, and then the micro-controller circuit 320 issues the control signal to the first switching module 290. Such an operation is much slower than the operation via hardware mechanism control; however, such an operation requires fewer pins to transmit and receive signals. Therefore, he preferable control mechanism among the second switch control pin 224 and the micro-controller circuit 320 depends on the actual requirement of the system. Moreover, the first switching module can be a electrical signal splitter for simultaneously coupling the terminal-end input port 221 to the input port 251 of the first laser driver circuit 250 and the input port 261 of the second laser driver circuit 260. By switching ON or OFF the first transmitting module 510 and the second transmitting module 520, the optical signals will be simultaneously transmitted to the first optical channel and the second optical channel or transmitted to one of the two.

The micro-controller circuit 320 further includes one or more output ports of a transmitting module failure signal 542, a first transmitting module disable signal 533. The micro-controller circuit 320 also includes one or more input ports of the transmitting module control port 541. The transmitting module failure signal 542 indicates whether the transmitting module functions normally. For example, when the main optical channel is the first optical channel and the first transmitting module 510 malfunctions to issue the first transmitting module failure signal 535 to the micro-controller circuit 320, the transmitting module failure signal 542 will issue corresponding signal accordingly. The transmitting module failure signal 542 can be coupled to one of the physical pins of the terminal-end interface 220 to inform the OLT or ONU about the malfunction of the transmitting module in time. The first transmitting module disable signal 533 and second transmitting module disable signal 534 respectively switch ON and switch OFF the first transmitting module 510 and the second transmitting module 520. The transmitting module control port 541 respectively uses physical pins to directly control ON and OFF of the first transmitting module 510 and the second transmitting module 520, For example, the transmitting module control port 541 is directly coupled to the micro-controller circuit to change output of the first transmitting module disable signal 533 and the second transmitting module disable signal 534. The advantage is that such an operation via hardware mechanism control is quick.

FIG. 5 is a control method of an optical fiber transmission switching device according to the present invention, applied for transmitting function as shown in FIG. 5. The control method includes the following steps.

As shown in Step 601, initially, the optical fiber transmission switching device is switched ON for resetting and initializing the optical fiber transmission switching device. The optical fiber transmission switching device loads values of various system parameters; for example, for example, the optical fiber transmission switching device restores the system parameters before the last system power OFF. Then, the first optical channel is designated as the main optical channel for transmitting data carried by the optical signals.

As shown in Step 602, then the system detects whether the designation of the main optical channel is changed to another optical channel. When the designation of the main optical channel is changed, the system changes the main optical channel to another optical channel as shown in Step 603, and then executes Step 604. For example, if the designation for the main optical channel is unchanged, the system directly executes Step 604. For example, the original designation for the main optical channel is the first optical channel, and the micro-controller circuit detects a first channel failure signal issued to indicate channel failure, the micro-controller circuit switches the second optical to be the new main optical channel.

As shown in Step 604, the system detects whether setup values corresponding ON and OFF of the first laser driver circuit and the second laser driver circuit have been changed. If the setup values have been changed, the system switches ON or OFF the first laser driver circuit and the second laser driver circuit according to the setup values as shown in Step 605, stores the setup values, and then returns Step 602. If the setup values remain unchanged, the system returns Step 602 directly.

An example is illustrated below. The first switching module is an electrical signal splitter which can simultaneously output the first electrical signal and the second electrical signal received from the terminal-end input port. If the original designation of the main optical channel is the first optical channel, and the first transmitting module failure signal indicates that the first optical channel malfunctions, the micro-controller circuit changes the designation of the main optical channel to the second optical channel, and goes to Step 603 to change the main optical channel to another optical channel. For example, the setup values are to switch ON the second laser driver circuit to output optical signals; in Steps 604 and 605, the system switches ON and OFF the first laser driver circuit and the second laser driver circuit according to setup values to enable one or both ends of the main optical channel.

Another example is illustrated below. The first switching module is a single-pole double-throw switch, and the original designation of the main optical channel is the first optical channel. When the first transmitting module failure signal is issued to indicate that the first optical channel malfunctions, the micro-controller circuit changes the designation of the main optical channel to the second optical channel, and goes Step 603 to change the main optical channel to another optical channel. For example, the system controls the first switching module to couple the terminal-end input port to the input port of the second laser and changes the setup values to switch ON the second laser driver circuit, so as to output the optical signals via the second optical channel. Step 604 and 605 are the same as disclosed in the above example.

As descriptions of the above two illustrations, when the transmitting module corresponding to one end of the main optical channel malfunctions to interrupt or abnormalize signal transmission, the system switch the data transmission channel to the redundant optical channel in time and designates the redundant optical channel to be the main optical channel, so as to prevent data transmission from being interrupted or abnormal. Besides, through switching ON and OFF the first transmitting module and the second transmitting module, the present invention increases the flexibility and expansion ability of system application.

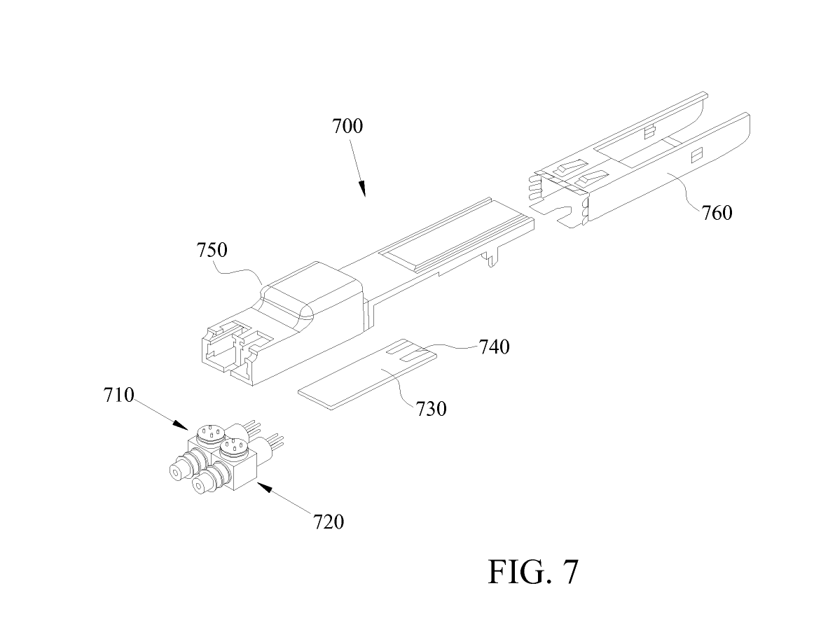

FIG. 7 is an explosive view of small form-factor pluggable (SFP) transceiver 700 applicable to the optical fiber transmission switching device 200 according to the present invention. The first optical module 710 and the second optical module 720 are similar to the first optical module 230 and the second optical module 240. The first laser driver circuit 250, the second laser driver circuit 260, the first electrical amplifier, the second electrical amplifier 280, the first switching module 290 and the second switching module 310, and the micro-controller circuit 320 are disposed on the electrical circuit board 730. The terminal-end interface 220 is similar to the terminal-end interface 740 in FIG. 7. The connector mechanism configured by the terminal-end interface is 220 Small form-factor pluggable (SFP) transceiver multi-source agreement (MSA). The SFP transceiver700 further includes a base 750 and protection housing 760. The base 750 is used for components to be disposed and combined thereon, and the base 750 also used for the first optical channel and the second optical channel inserting thereinto and connecting to the first optical module 710 and the second optical module 720. The protection housing 760 is sued to protect the internal component therein.

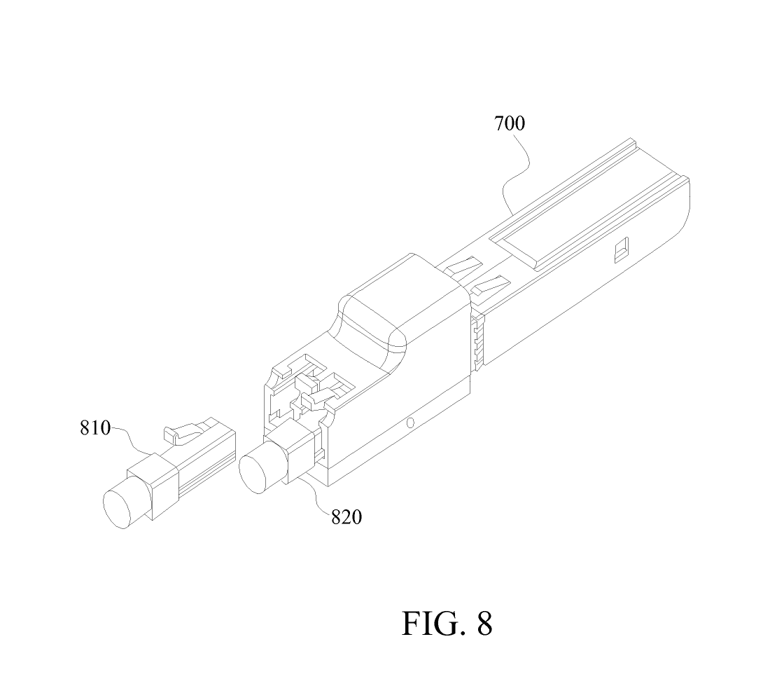

FIG. 8 is perspective view of the SFP transceiver 700. FIG. 8 further shows a first optical channel connector 810 and a second optical channel connector 820. The first optical channel connector 810 shown in FIG. 8 does not insert into the SPF transceiver 700, and the second optical channel connector 820 has inserted into the SPF transceiver 700. Moreover, the SPF transceiver 700 inserts into OLT or ONU via the connector mechanism configured by the terminal-end interface 220. The advantage of the optical fiber transmission switching device 200 applicable to the SPF transceiver 700 of the present invention lies in that under compatible with the connector mechanism of the current terminal device, the SPF transceiver 700 further provides an additional data transmission module for the redundant optical channel. Therefore, volume of the transceiver and the number of the insertion holes of the OLT/ONU are reduced. The end of the SFP transceiver 700 used to be the redundant optical channel can also provide Digital Diagnostics Monitoring (DDM) function, such that the system can monitor internal components or channel real timely to optimize the control procedure.

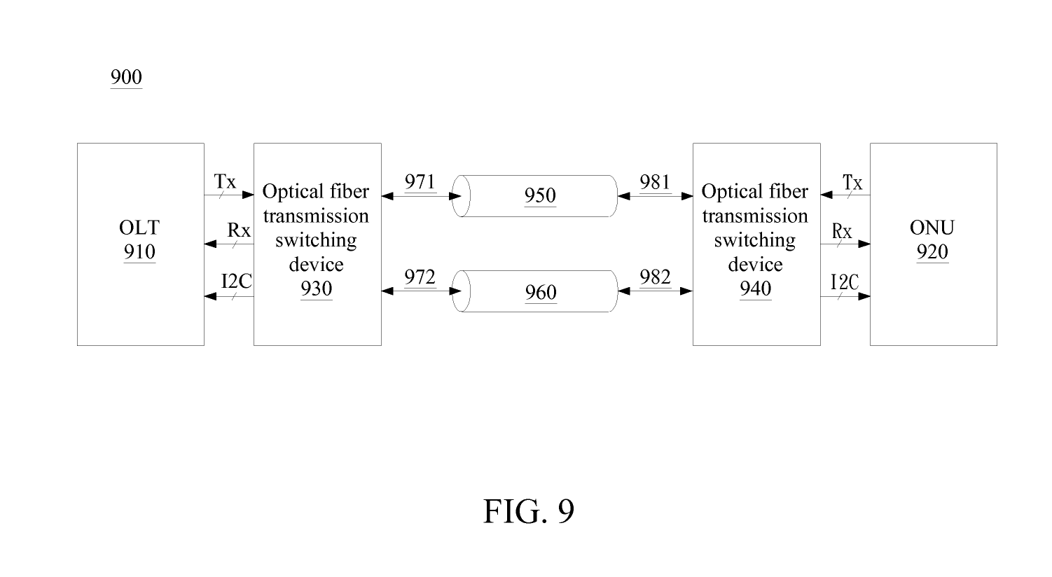

FIG. 9 is a schematic diagram of an optical network adopting the optical fiber transmission switching device 200 of the present invention. the optical network 900 can be a passive optical network, which includes an OLT 910, an ONU 920, optical fiber transmission switching devices 930/940, a first optical channel 950, and a second optical channel 950, an OLT first bi-directional optical port 971, an OLT second bi-directional optical port 972, an ONU first bi-directional optical port 981, an ONU second bi-directional optical port 982. The optical fiber transmission switching device 930/940 are the same as those disclosed in the other embodiment of the present invention, for example the optical fiber transmission switching device 930/940 are the same as or similar to the SFP transceiver 700 in FIG. 7 and FIG. 8. The OLT first and second bi-directional optical ports 971/972 are used to couple the optical fiber transmission switching device 930 to the first optical channel 950 and the second optical channel 960 respectively. The ONU first bi-directional optical port 981 and the ONU second bi-directional optical port 982 are used to couple the optical fiber transmission switching device 940 to the first optical channel 950 and the second optical channel 960 respectively.

As shown in FIG. 9, an example of the operation of the optical network 900 is illustrated hereinafter. Firstly, the optical fiber transmission switching devices 930/940 are set to simultaneously output signals to the first optical channel 950 and the second optical channel 960 respectively, and the first optical channel 950 is designated to be the original main optical channel. The optical fiber transmission switching devices 930/940 transforms the optical signals received from first optical channel 950 into electrical signals, and then outputs the electrical signals to OLT 910 and ONU 920. If the first optical channel 950 as the main optical channel is damaged due to external or other unknown reason and the optical signals received by the optical fiber transmission switching devices 930/940 become abnormal, the optical fiber transmission switching devices 930/940 switch the main optical channel to the second optical channel 960 in time. The second optical channel 960 transmits signals as well as transmitted in the first optical channel 950, so that the OLT 910 and the ONU 920 can receive data in time without being interrupted. Since data transmission is not interrupted, data loss among the period for switching the channel is reduced. However, the system drive the first optical channel and the second optical channel 950 simultaneously, the system power consumption is relative high.

If the first optical channel 950 as the main optical channel is damaged due to external or other unknown reason and the optical signals received by the optical fiber transmission switching devices 930/940 become abnormal, the optical fiber transmission switching devices 930/940 switch the main optical channel to another optical channel 960 in time. In this example, only one of the first optical channel 950 and the second optical channel 960 is operated, such that the system power consumption is relative lower than the aforementioned example.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention

What is claimed is:

1. An optical fiber transmission switching device for an optical network, comprising:
a channel-end interface, including a first transmission port and a second transmission port;
a terminal-end interface, including a terminal-end input port and a terminal-end output port;
a first optical module, including a bi-directional optical port coupled to the first transmission port, an electrical output port, an electrical input port, a laser diode and an optical sensor;
wherein the laser diode transforms electrical signals input via the electrical input port into optical signals and outputs the optical signals via the bi-directional optical port, and the optical sensor transforms the optical signals input via the bi-directional optical port into electrical signals and outputs the electrical signals via the electrical output port;
a second optical module, including a bi-directional optical port coupled to the second transmission port, an electrical output port, an electrical input port, a laser diode and an optical sensor; wherein the laser diode transforms the electrical signals input via the electrical input port into the optical signals and output the optical signals via the bi-directional optical port, and the optical sensor transforms the optical signals input via the bi-directional optical port into electrical signals and output the electrical signals via the electrical output port;
a first laser driver circuit, including an input port and an output port; wherein the output port is coupled to the electrical input port of the first optical module;
a second laser driver circuit, including an input port and an output port; wherein the output port is coupled to the electrical input port of the second optical module;
a first electrical amplifier, including an input port and an output port; wherein the input port is coupled to the electrical output port of the first optical module;
a second electrical amplifier, including an input port and an output port; wherein the input port is coupled to the electrical output port of the second optical module;
a first switching module, including an input port, a first output port and an second output port; wherein the input port is coupled to the terminal-end input port, the first output port is coupled to the input port of the first laser driver circuit, and the second output port is coupled to the input port of the second laser driver circuit; and
a second switching module, including a first input port, a second input port and an output port; wherein the first input port is coupled to the output port of the first electrical amplifier, the second input port is coupled to the output of the second electrical amplifier, the output port is coupled to the terminal-end output port;
wherein when the transmission of the optical signals at the first transmission port function normally, the electrical signals at the terminal-end output port are transformed from the optical signals received via the first transmission port; when the transmission of the optical signals at the first transmission port malfunctions, the electrical signals at the terminal-end output port are transformed from the optical signals received via the second transmission port.

2. The optical fiber transmission switching device as claimed in claim 1, wherein the optical network is a passive optical network.

3. The optical fiber transmission switching device as claimed in claim 1, wherein the terminal-end interface includes twenty pins interface applicable to small form-factor pluggable transceiver multi-source agreement.

4. The optical fiber transmission switching device as claimed in claim 1, further comprising a micro-controller circuit coupled to the first optical module and the second optical module, functioning as means for digital diagnostics monitoring.

5. The optical fiber transmission switching device as claimed in claim 4, wherein the second switching module is a double-pole single-throw switch controlled by a second switch control pin of the terminal-end interface or controlled by the micro-controller circuit, for selectively switching the terminal-end output port to couple to the output port of the first electrical amplifier or the output port of the second electrical amplifier.

6. The optical fiber transmission switching device as claimed in claim 4, wherein the first switching module is a single-pole double-throw switch, controlled by a first switch control pin of the terminal-end interface or controlled by the micro-controller circuit, when the transmission of the optical signals at the first transmission port functions normally, the first switching module switches the terminal-end input port to couple to the input port of the first laser driver circuit, and hen the transmission of the optical signals at the first transmission port malfunctions, the first switching module switches the terminal-end input port to couple to the input port of the second laser driver circuit.

7. The optical fiber transmission switching device as claimed in claim 4, wherein the first switching module is an electrical signal splitter, for coupling the terminal-end input port to the input port of the first laser driver circuit and the input port of the second laser driver circuit simultaneously, and the micro-controller circuit respectively switches ON or switches OFF the first laser driver circuit and the second laser driver circuit, so as to output optical signal via one or both of the first transmission port and the second transmission port.

8. A control method, applicable to the optical fiber transmission switching device as claimed in claim 4, wherein the first second optical module and the second optical module respectively comprises a first channel failure signal and a second channel failure signal, and the first channel failure signal and the second channel failure signal respectively indicate whether a first optical channel inserting into the first transmission port and a second optical channel inserting into the second transmission port function normally; and the micro-controller circuit further comprises a system channel failure signal for indicating whether a main channel functions normally, the control method comprising:
resetting the optical fiber transmission switching device, and designating the first optical channel as the main channel for transmitting data carried by optical signals;
detecting whether the designation of the main channel is changed to another optical channel; when the designation of the main channel is changed, changing the main channel to the other optical channel; and
detecting whether the main channel issues a channel failure signal, when the main channel issues the channel failure signal, micro-controller circuit outputs a system channel failure and then returning the step for detecting whether the designation of the main channel is changed to another optical channel; when the main channel issues the channel failure signal, returning the step for detecting whether the designation of the main channel is changed to another optical channel without issuing the system channel failure.

9. The control method as claimed in claim 8, wherein the step for detecting whether the main channel issues a channel failure signal comprises:
designating the first optical channel as the main channel via the micro-controller circuit when the main channel is the second optical channel and the first channel failure signal is not issued.

10. The control method as claimed in claim 8, wherein the step for detecting whether the main channel issues a channel failure signal comprises:
when the main channel is the second optical channel, the micro-controller circuit does not change the designation of the main channel.

11. The control method as claimed in claim 8, wherein the step for detecting whether the main channel issues a channel failure signal comprises:
when the main channel issues the channel failure signal, the micro-controller circuit changes the designation of the main channel to another optical channel.

12. The control method as claimed in claim 8, wherein the designation of the main channel is controlled by a second switch control pin of the terminal-end interface or controlled by the micro-controller circuit.

13. A control method, applicable to the optical fiber transmission switching device as claimed in claim 4, comprising:
resetting the optical fiber transmission switching device, and designating the first optical channel as a main channel for transmitting data carried by optical signals;
detecting whether the designation of the main channel is changed to another optical channel; when the designation of the main channel is changed, changing the main channel to the other optical channel; and
detecting whether setting values of the first laser driver circuit and second laser driver circuit are changed; when the setting values are changed, switching ON or switching OFF the first laser driver circuit and second laser driver circuit according to the setting values and storing the setting values, and then returning the step for detecting whether the designation of the main channel is changed to another optical channel; when the setting values remain unchanged, returning the step for detecting whether the designation of the main channel is changed to another optical channel.

14. The control method as claimed in claim 13, wherein the micro-controller circuit respectively switches ON or switches OFF the first laser driver circuit and the second laser driver circuit.
